(19) United States
(12) Patent Application Publication
(10) Pub. No.: US 2005/0019652 A1
(43) Pub. Date: Jan. 27, 2005

(54) Electrode assembly and method of manufacturing same

(76) Inventor: Denis G. Fauteux, Deerfield Beach, FL (US)

Correspondence Address: FACTOR & LAKE, LTD, 1327 W. WASHINGTON BLVD., SUITE 5G/H, CHICAGO, IL, 60607, US

(21) Appl. No.: 10/624,127

(22) Filed: Jul. 21, 2003

(51) Int. Cl. H01M 2/18; H01M 4/70

(52) U.S. Cl. 429/129; 429/128; 429/246; 429/233; 29/623.2; 29/623.4

(57) ABSTRACT

An electrode assembly divided into a plurality of segments which are each separated by a fold, to, in turn, facilitate a fan-fold orientation. The assembly comprises a separator, an anode active material, a cathode active material, an anode current collector and a cathode current collector. Portions of the separator corresponding to at least one of the folds are substantially free of at least one of anode active material and cathode active material resulting in a gap between the respective side of the separator and the respective current collector. Additionally, the upper edge of one of the anode side and the cathode side of the separator and the lower edge of one of the anode side and the cathode side of the separator are substantially free of the respective anode or cathode active material and the respective anode or cathode current collector. Moreover, at least one of the anode current collector and the cathode current collector includes at least one slit corresponding to at least one fold of the electrode assembly

### BACKGROUND OF THE INVENTION

1. Field of the Invention

The invention relates in general to an electrode assembly, and more particularly to a fan-fold (i.e. accordion fold) electrode assembly for use in association with secondary cells, such as lithium-ion based cells.

2. Background Art

The use of lithium based cells is known in the art. As an example, lithium based cells comprising a single layered material (including a current collector, anode, cathode and separator) are “fan-folded” (i.e. accordion folded) to define a stack of cells in a zig-zag configuration. While such fan-fold cells are known, there have been certain problems associated with their application. First, as current designs extend the anode, cathode, and current collectors to the upper and lower edges of the layered material, the possibility of short-circuiting is presented due to the proximity of these components. Moreover, such a construction requires strict tolerances during manufacture.

Moreover, conventional designs tend to be problematic proximate the fold regions. In particular, the construction of the layered material leads to material fatigue, stress concentrations, and current concentrations proximate the fold regions.

Accordingly, it is an object of the present invention to provide a fan-fold electrode assembly which minimizes unintended interaction between the anode and cathode.

It is another object of the invention to simplify the manufacture of a fan-fold electrode assembly.

It is yet another object of the invention to improve the construction of the fan-fold electrode assembly proximate the fold regions.

These and other objectives will become apparent in light of the present specification, drawings and claims appended hereto.

### SUMMARY OF THE INVENTION

The invention comprises an electrode assembly divided into a plurality of segments which are each separated by a fold, to, in turn, facilitate a fan-fold orientation. The assembly comprises a separator, an anode active material, a cathode active material, an anode current collector and a cathode current collector. The separator includes an anode side and a cathode side. The anode active material is applied to at least a portion of the anode current collector. The cathode active material is applied to at least a portion of the cathode current collector. Portions of the separator corresponding to at least one of the folds are substantially free of at least one of the anode active material and cathode active material. This results in a gap between the respective side of the separator and the respective current collector. The anode active material is associated with the anode side of the separator and the cathode active material is associated with the cathode side of the separator preferably via an adhesive, or any other suitable means.

In a preferred embodiment, the portions of the separator corresponding to at least one of the folds are substantially free of each of the anode active material and the cathode active material. This results in a gap between each side of the separator and the respective current collector associated therewith. In one such embodiment, such an assembly appears at each of the folds.

In one embodiment, the separator includes an upper edge and a lower edge. At least a portion of the upper edge of one of the anode side and the cathode side of the separator and at least a portion of the lower edge of one of the anode side and the cathode side of the separator is substantially free of the respective anode or cathode active material and the respective anode or cathode current collector. In one embodiment each of the upper and lower edges of the anode are substantially free of anode active material and the anode current collector. In one particular embodiment, the cathode active material and the cathode current collector are coextent and are substantially centered along the separator. Preferably, the cathode active material is either substantially similar or smaller in surface area covered in comparison to the anode active material due to cell balance considerations. As a result, the separator may be substantially similar or greater in surface area covered in comparison to the anode active material.

In one embodiment, at least one of the anode current collector and the cathode current collector includes at least one slit corresponding to at least one fold of the electrode assembly. In one such embodiment, each of the anode current collector and the cathode current collector includes at least one slit corresponding to at least one fold of the electrode assembly. Preferably such a structure is seen at each of the folds of the electrode assembly.

In another aspect of the invention, the assembly comprises a separator, an anode active material, a cathode active material, an anode current collector and a cathode current collector. The separator includes an anode side and a cathode side. The anode active material is applied to a portion of the anode side of the separator. The cathode active material is applied to the cathode side of the separator. The anode current collector is applied to the surface of the anode active material. The cathode current collector is applied to the surface of the cathode active material. The separator further includes an upper edge and a lower edge. At least a portion of the upper edge of one of the anode side and the cathode side of the separator and at least a portion of the lower edge of one of the anode side and the cathode side of the separator are substantially free of the respective anode or cathode active material and the respective anode or cathode current collector.

In another aspect of the invention, the above-described assembly further includes at least one slit corresponding to at least one fold of the electrode assembly.

In another aspect of the invention, the invention comprises a method of manufacturing an electrode assembly. In a preferred embodiment, the method comprises the steps of providing a separator having an anode side and a cathode side, providing a first active material comprising one of an anode active material and a cathode active material, providing an adhesive on a top surface of the separator on at least one of the anode side and cathode side, and joining the first active material with the corresponding side of the separator. In another embodiment of the manufacturing method, the method alternatively includes the steps of applying a solvent to one of the first active material and the corresponding side of the separator, placing the first active material onto the corresponding side of the separator, prior to evaporation of the solvent, and, joining the first active material with the corresponding side of the separator.

In a preferred embodiment, the step of providing a first active material comprises the steps of providing an anode current collector; and, applying an anode active material to one side of the anode current collector.

In another preferred embodiment, the step of providing a first active material comprises the steps of providing a cathode current collector, and, applying a cathode active material to one side of the cathode current collector.

In yet another preferred embodiment, the step of joining further comprises the step of pressing the first active material against the separator. In one such embodiment, the step of joining further comprises the step of heating the first active material and the separator. In a preferred embodiment, the steps of heating the first active material and separator and pressing the first active material against the separator are performed simultaneously. In another embodiment, the first active material comprises an anode active material and a cathode active material, and the anode active material is heated and pressed on the anode side of the separator and the cathode active material is subsequently heated and pressed on the cathode side of the separator. In yet another embodiment, the step of heating the first active material follows the step of pressing the first material against the separator.

In another preferred embodiment, the method further comprises the steps of providing a second active material comprising the other of an anode active material and a cathode active material, applying a solvent to one of the second active material and the corresponding side of the separator, placing the second active material onto the corresponding side of the separator, prior to evaporation of the solvent, and, joining the second active material with the corresponding side of the separator.

In one embodiment, the method further comprises the step of folding the joined first active material and separator into a fan-fold orientation.

In another aspect of the invention, the invention comprises a method of manufacturing an electrode assembly. The method comprises the steps of providing a first current collector having at least one fold region (wherein the first current collector comprises one of an anode current collector and a cathode current collector), applying a first active material to the first current collector (wherein the first active material corresponds to the respective anode active material and cathode active material), removing the first active material from the first current collector proximate the at least one fold region, providing a separator having a fold regions corresponding to each of the at least one fold region of the first current collector, and, joining the first active material to the separator. The step of joining associates the fold regions of each of the first current collector and separator. In a preferred embodiment, the step of removing the first active material from the first current collector proximate the at least one fold region is performed via laser.

In one preferred embodiment, the method further comprises the step of forming slits in at least one of the fold regions of the first current collector. Preferably, the slits are formed via laser.

In another preferred embodiment method further comprises the steps of providing a second current collector having at least one fold region (wherein the second current collector is the other of an anode current collector and a cathode current collector), applying a second active material to the second current collector (wherein the second active material is the other of an anode current collector and a cathode current collector), removing the second active material from the second current collector proximate the at least one fold region, and, joining the second active material to the opposite side of the separator to which the first active material is joined. This step of joining, in turn, associates the fold regions of each of the second current collector and separator.

Preferably, the step of removing is achieved through one of abrading, laser removal, and applying a solvent.

### BRIEF DESCRIPTION OF THE DRAWINGS

FIG. 1 of the drawings is a perspective view of the electrode assembly of the present invention;

FIG. 2 of the drawings is a side elevational view of the electrode assembly of the present invention;

FIG. 3 of the drawings is a cross-sectional view of the electrode assembly of the present invention, taken generally about lines 3-3 of FIG. 1;

FIG. 4 of the drawings is a cross-sectional view of the electrode assembly of the present invention, taken generally about lines 4-4 of FIG. 1;

FIG. 5 of the drawings is a perspective view of two adjoining segments of the electrode assembly;

FIG. 6 of the drawings is a cross-sectional view of the electrode assembly with leads attached thereto and positioned within a container;

FIG. 7 of the drawings is a schematic representation of one embodiment of a method of manufacturing the electrode assembly of the present invention; and

FIG. 8 of the drawings is a schematic representation of another embodiment of a method of manufacturing the electrode assembly of the present invention.

### BEST MODE FOR PRACTICING THE INVENTION

While this invention is susceptible of embodiment in many different forms, there is shown in the drawings and will be described in detail, one specific embodiment with the understanding that the present disclosure is to be considered as an exemplification of the principles of the invention and is not intended to limit the invention to the embodiment illustrated.

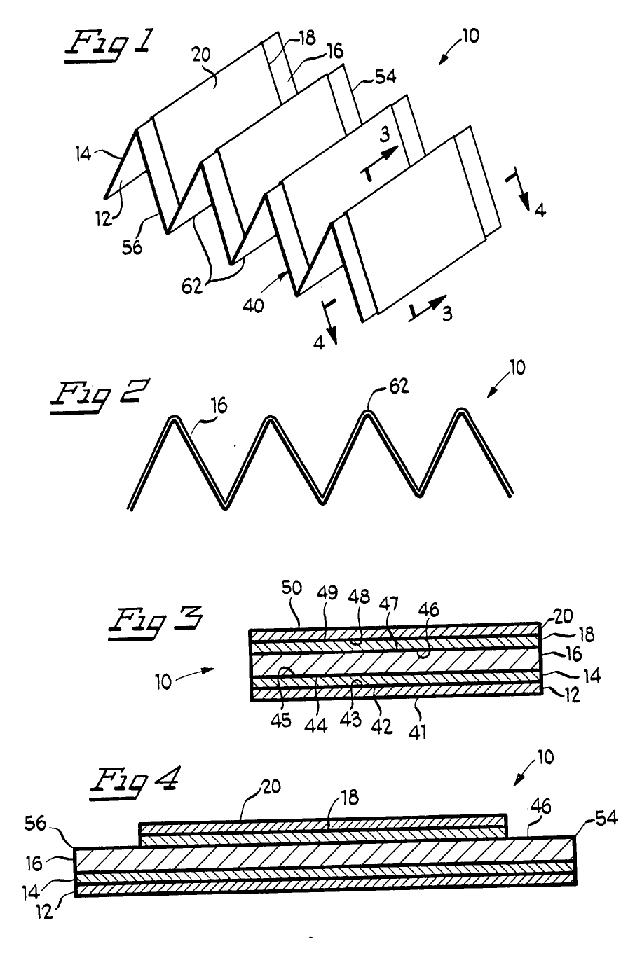

Referring now to the figures, and in particular to FIG. 1, electrode assembly is shown generally at 10. The electrode assembly is configured for use in association with batteries, such as secondary batteries, and, preferably, lithium ion batteries.

As shown in FIG. 1, electrode assembly 10 includes anode current collector 12, anode active material 14, separator 16, cathode active material 18 and cathode current collector 20. Electrode assembly 10 comprises a length of material having an upper edge 54 and a lower edge 56. The length is the sum of a plurality of segments, such as segment 40, which are separated from each other by folds, such as folds 62 which extend from upper edge 54 to lower edge 56. As will be explained in detail below, and as shown in FIG. 2, the segments are folded back and forth along folds 62 into an accordion like shape. Generally, separator 16 is contiguous about the entire length of electrode assembly.

The cross-sectional structure of electrode assembly is shown in FIG. 3. In particular, anode current collector 12 includes upper surface 41 and lower surface 42. The anode current collector may comprise a metal such as copper or the like. Anode active material 14 includes upper surface 43 and lower surface 44. The separator includes anode surface 45 and cathode surface 46. Cathode active material 18 includes upper surface 47 and lower surface 48. Current collector 20 includes upper surface 49 and lower surface 50. The cathode current collector may comprise a conductive metal, such as aluminum or the like. The anode, cathode and current collector may comprise any number of different conventional and proprietary materials.

As shown in FIG. 3, the electrode assembly is arranged such that anode surface 45 of separator 16 is associated with lower surface 44 of anode active material 14, and cathode surface 46 of separator 16 is associated with upper surface 47 of cathode active material 18. The lower surface 44 is preferably associated with anode surface 45 and cathode surface 46 is preferably associated with cathode surface 46 via an adhesive, or any other suitable means. In addition, the respective active material and current collector are coextent (i.e., they overlie each other and have substantially the same surface area). In turn, upper surface 43 of anode active material 14 is associated with lower surface 42 of anode current collector 12. Similarly, lower surface 48 of cathode active material 18 is associated with upper surface 49 of cathode current collector 20.

Referring now to FIG. 4, cathode current collector 18 and cathode current collector 20 are not as wide as separator 16, anode active material 14 and anode current collector 12. In such a manner, there is an area of cathode surface 46 of the separator which remains exposed and which is not covered by the cathode active material and the cathode current collector. Such an area of the exposed cathode surface of the separator can be proximate both of upper edge 54 and lower edge 56. Moreover, while the exposed separator surface is generally identical at each of the upper and lower edges of the assembly (i.e., the active materials and current collectors are centered about the separator), these regions need not be identical in size and shape. In another embodiment, a similar construction can be applied to the anode side of the separator such that a portion of the anode side of separator 16 remains visible. Preferably, the surface area covered by the anode active material is greater than that of the cathode active material which results in improved performance and a lower likelihood of dendrite growth and shorting. As a result, the separator may be substantially similar or greater in surface area covered in comparison to the anode active material.

Referring now to FIG. 5, separator 16 is substantially contiguous about the entire length of electrode assembly 10. Preferably, each of anode active material 14 and cathode active material 18 are substantially discontinuous about each of folds 62 (of course it is likewise contemplated that such discontinuous regions are located along only one side of the separator). The gap around each of folds 62 is about 2 mm, while other dimensions are likewise contemplated. In this manner, the thickness of material proximate folds 62 can be minimized, and concentrations of current can be avoided. As will be explained, various manufacturing methods are contemplated for removal of active material from these regions.

Referring again to FIG. 5, each of anode current collector 12 and cathode current collector 20 may include one or more slits (or breaks in material) 64 which overlie any one or more of folds 62. In the embodiment shown, anode current collector 12 includes four slits. As such, while the anode current collector 12 comprises a continuous material, the slits facilitate the bending of the assembly along folds 62. It will be understood to one of skill in the art, the particular quantity and/or shape of the slits can be varied without extending beyond the scope of the invention.

To manufacture such an electrode assembly, a conventional electrode slurry is applied to a conventional current collector. Next, the current collector with the applied slurry is cut into an appropriate size. Once cut into the appropriate sizes, the electrode slurry is removed from portions of the current collector (i.e., proximate the fold regions). This may be done by way of a solvent or by way of abrasion, for example. While various different embodiments are contemplated, in one embodiment, a coated region may be 28 mm wide and the gaps between the coated regions may be 2 mm wide. The same process can be utilized for each of the anode side and cathode side, wherein it will be understood that the particular current collector and active material may be different for each of the anode and cathode sides.

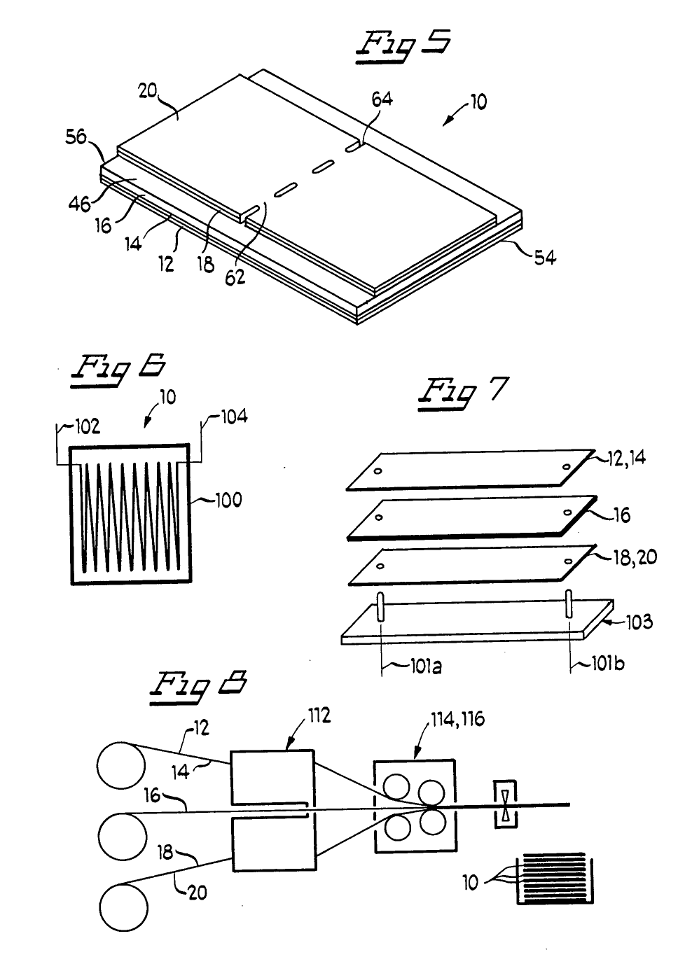

As shown in FIG. 7, once the completed active material and current collector is cut to the desired size, registration points 101a, 101b can defined which facilitate alignment and maintenance within specially prepared jig 103. Next, slits are formed into the current collector. The slits may be cut or otherwise punched, to in turn, render slits (i.e. slits 64). In one embodiment, the slits may be about 1 mm wide and 7 mm long, while different configurations are contemplated. In a preferred embodiment, a conventional laser is used to form slits.

After the slit forming operation is completed, a solvent is applied by spraying, rolling or other means to the respective anode and cathode active materials (or onto the separator). The solvents may include materials such as gamma butyrolactone or mixtures such as an EC/DC mixture. In other embodiments, a polymer can be added to the solvent to help with toughness (i.e., PDEF or PMMA). Before the solvent evaporates, the separator and the respective material are placed into contact and pressed against each other to join the two materials together. Optionally, the pressing can occur at an elevated temperature, i.e. 110 C, to further facilitate bonding. It will be understood that the solvent creates a tacky or adhesive interface on the surface of the separator to promote adhesion.

In a preferred embodiment, a conventional laser is used to form portions of the separator 16 corresponding to at least one of the folds 62 which are substantially free of at least one of the anode active material 14 and cathode active material 18.

In one embodiment, as shown in FIG. 8, the prepared anode current collector and anode active material, the prepared cathode current collector and cathode material and the separator can each comprise a continuous web of material. In such an embodiment, the two current collector webs having active material disposed thereon first proceed through solvent station 112 wherein solvent is applied to the respective active materials. Subsequently, the three webs proceed to pressing station 114, wherein the current collectors (treated with solvent) can be pressed against the separator to join the layers. In addition, the press may include heating device 116 which can raise the temperature within the press to a desired elevated temperature, such as, for example, 110 C. Once fully joined, the assembled web can proceed to a cutting station, wherein the web is cut into electrode assemblies of an appropriate desired length. Once cut, the complete electrode assembly can be fan-folded into the above-described orientation.

It will be understood that in such an embodiment, the current collectors may be fully prepared, or, alternatively, an abrasion station and slit punching station may be positioned prior to the solvent application station so that the current collectors can be properly slit proximate the intended fold regions and so that active material can be removed proximate the intended fold regions. Indeed, it is also contemplated that a folding initiating station can be incorporated prior to joining the webs or after joining the webs so that later folding into the desired fan-fold orientation can be facilitated.

Indeed, once all of the layers have been assembled, as shown in FIG. 2, electrode assembly 10 is folded in a zig-zag or accordion configuration along folds 62. In turn, with the exception of the end segments at either end of the electrode assembly, the segments are positioned such that the anode current collector of two adjacent segments are in a back to back orientation and the cathode current collector of two adjacent segments are in a back to back orientation.

Once fully assembled, as shown in FIG. 6, the electrode assembly can be positioned within a container, such as container 100. Next, a liquid electrolyte can be introduced to the electrode assembly, and leads 102, 104 can be associated with the cathode current collector at one end and the anode current collector at the other end. In another embodiment, a gel based electrolyte can be applied as a coating onto the electrode assembly.

Advantageously, since one of the anode side and the cathode side of the separator proximate each of the upper and lower edge of the assembly remain exposed (i.e., not covered by anode or cathode active material or a current collector), the risk of short circuiting is substantially reduced. Moreover, during manufacturing, application of the smaller current collector (i.e., the current collector that does not extend from the upper to the lower edge of the assembly), is facilitated, as the edges of the separator can be used for alignment purposes. Moreover, as the material at each of the folds 62 is minimized through removal of active material and slitting of current collectors, the bending of the electrode assembly about the folds is facilitated, and the possibility of forming current concentrations is substantially avoided.

The foregoing description merely explains and illustrates the invention and the invention is not limited thereto except insofar as the appended claims are so limited, as those skilled in the art who have the disclosure before them will be able to make modifications without departing from the scope of the invention.

1. An electrode assembly divided into a plurality of segments which are each separated by a fold, to, in turn, facilitate a fan-fold orientation, comprising:
a separator having an anode side and a cathode side;
an anode current collector and a cathode current collector, wherein an anode active material is associated with the anode current collector, and wherein, a cathode active material is associated with the cathode current collector, and wherein, the anode active material is associated with at least a portion of the anode side, and wherein, the cathode active material is associated with at least a portion of the cathode side; and
wherein the portions of the separator corresponding to at least one of the folds are substantially free of at least one of the anode active material and cathode active material resulting in a gap between the respective side of the separator and the respective current collector.

2. The electrode assembly of claim 1 wherein the portions of the separator corresponding to at least one of the folds are substantially free of each of the anode active material and the cathode active material resulting in a gap between each side of the separator and the respective current collector.

3. The electrode assembly of claim 1 wherein the portions of the separator corresponding to each of the folds are substantially free of each of the anode active material and cathode active material resulting in a gap between each side of the separator and the respective current collector proximate each of the folds.

4. The electrode assembly of claim 1 wherein the separator includes an upper edge and a lower edge, at least a portion of the upper edge of one of the anode side and the cathode side of the separator and at least a portion of the lower edge of one of the anode side and the cathode side of the separator being substantially free of at least one of the respective anode and cathode active material and at least one of the respective anode and cathode current collector.

5. The electrode assembly of claim 4 wherein the upper and the lower edge of the cathode side of the separator being substantially free of cathode active material and the cathode current collector.

6. The electrode assembly of claim 5 wherein the cathode active material and the cathode current collector are coextent and are substantially centered along the separator.

7. The electrode assembly of claim 1 wherein the anode current collector is coextent with the anode active material.

8. The electrode assembly of claim 1 wherein the cathode current collector is coextent with the cathode active material.

9. The electrode assembly of claim 1 wherein at least one of a portion of the anode active material and a portion of the cathode active material is associated with at least one of a portion of the anode side and a portion of the cathode side respectively via an adhesive.

10. The electrode assembly of claim 1 wherein at least one of the anode current collector and the cathode current collector includes at least one slit corresponding to at least one fold of the electrode assembly.

11. The electrode assembly of claim 1 wherein each of the anode current collector and the cathode current collector includes at least one slit corresponding to at least one fold of the electrode assembly.

12. The electrode assembly of claim 10 wherein each of the anode current collector and the cathode current collector each include at least one slit corresponding to each of the folds of the electrode assembly.

13. An electrode assembly divided into a plurality of segments which are each separated by a fold, to, in turn, facilitate a fan-fold orientation, comprising:
a separator having an anode side and a cathode side;
an anode current collector and a cathode current collector, wherein an anode active material is associated with the anode current collector, and wherein, a cathode active material is associated with the cathode current collector, and wherein, the anode active material is associated with at least a portion of the anode side, and wherein, the cathode active material is associated with at least a portion of the cathode side; and
wherein the separator includes an upper edge and a lower edge, at least a portion of the upper edge of one of the anode side and the cathode side of the separator and at least a portion of the lower edge of one of the anode side and the cathode side of the separator being substantially free of the respective anode or cathode active material and the respective anode or cathode current collector.

14. The electrode assembly of claim 13 wherein the upper and the lower edge of the cathode side of the separator being substantially free of cathode active material and the cathode current collector.

15. The electrode assembly of claim 14 wherein the cathode active material and the cathode current collector are coextent and are substantially centered along the separator.

16. The electrode assembly of claim 13 wherein the portions of the separator corresponding to at least one of the folds are substantially free of each of the anode active material and the cathode active material resulting in a gap between each side of the separator and the respective current collector.

17. The electrode assembly of claim 13 wherein the portions of the separator corresponding to each of the folds are substantially free of each of the anode active material and cathode active material resulting in a gap between each side of the separator and the respective current collector proximate each of the folds.

18. The electrode assembly of claim 13 wherein the anode current collector is coextent with the anode active material.

19. The electrode assembly of claim 13 wherein the cathode current collector is coextent with the cathode active material.

20. The electrode assembly of claim 13 wherein at least one of a portion of the anode active material and a portion of the cathode active material is associated with at least one of a portion of the anode side and a portion of the cathode side respectively via an adhesive.

21. The electrode assembly of claim 13 wherein the at least one of the anode current collector and the cathode current collector includes at least one slit corresponding to at least one fold of the electrode assembly.

22. The electrode assembly of claim 13 wherein each of the anode current collector and the cathode current collector includes at least one slit corresponding to at least one fold of the electrode assembly.

23. The electrode assembly of claim 13 wherein each of the anode current collector and the cathode current collector each include at least one slit corresponding to each of the folds of the electrode assembly.

24. An electrode assembly divided into a plurality of segments which are each separated by a fold, to, in turn, facilitate a fan-fold orientation, comprising:
a separator having an anode side and a cathode side;
an anode current collector and a cathode current collector, wherein an anode active material is associated with the anode current collector, and wherein, a cathode active material is associated with the cathode current collector, and wherein, the anode active material is associated with at least a portion of the anode side, and wherein, the cathode active material is associated with at least a portion of the cathode side; and
wherein at least one of the anode current collector and the cathode current collector includes at least one slit corresponding to at least one fold of the electrode assembly.

25. The electrode assembly of claim 24 wherein each of the anode current collector and the cathode current collector includes at least one slit corresponding to at least one fold of the electrode assembly.

26. The electrode assembly of claim 24 wherein each of the anode current collector and the cathode current collector each include at least one slit corresponding to each of the folds of the electrode assembly.

27. The electrode assembly of claim 24 wherein the portions of the separator corresponding to at least one of the folds are substantially free of each of the anode active material and the cathode active material resulting in a gap between each side of the separator and the respective current collector.

28. The electrode assembly of claim 24 wherein the portions of the separator corresponding to each of the folds are substantially free of each of the anode active material and cathode active material resulting in a gap between each side of the separator and the respective current collector proximate each of the folds.

29. The electrode assembly of claim 24 wherein the anode current collector is coextent with the anode active material.

30. The electrode assembly of claim 24 wherein the cathode current collector is coextent with the cathode active material.

31. The electrode assembly of claim 24 wherein at least one of a portion of the anode active material and a portion of the cathode active material is associated with at least one of a portion of the anode side and a portion of the cathode side respectively via an adhesive.

32. A method of manufacturing an electrode assembly comprising the steps of
providing a separator having an anode side and a cathode side;
providing a first active material comprising one of an anode active material and a cathode active material;
providing an adhesive on a top surface of the separator on at least one of the anode side and cathode side; and
joining the first active material with the corresponding side of the separator.

33. The method according to claim 32 wherein the step of providing a first active material comprises the steps of:
providing an anode current collector; and
applying the anode active material to one side of the anode current collector.

34. The method according to claim 32 wherein the step of providing a first active material comprises the steps of:
providing an cathode current collector; and
applying the cathode active material to one side of the cathode current collector.

35. The method of claim 32 wherein at least one of a portion of the anode active material and a portion of the cathode active material is associated with at least one of a portion of the anode side and a portion of the cathode side respectively via an adhesive.

36. The method according to claim 32 wherein the step of joining further comprises the step of
pressing the first active material against the separator.

37. The method according to claim 32 wherein the step of joining further comprises the step of
heating the first active material and the separator.

38. The method according to claim 37, wherein the steps of pressing the first active material against the separator and heating the first active material and the separator are conducted simultaneously.

39. The method according to claim 32 further comprising the step of
folding the joined first active material and separator into a fan-fold orientation.

40. A method of manufacturing an electrode assembly comprising the steps of:
providing a first current collector having a at least one fold region, the first current collector comprising one of an anode current collector and a cathode current collector;
applying a first active material to the first current collector, the first active material corresponding to the respective anode active material and cathode active material;
removing the first active material from the first current collector proximate the at least one fold region;
providing a separator having a fold regions corresponding to each of the at least one fold region of the first current collector; and
joining the first active material to the separator to, in turn, associate the fold regions of each of the first current collector and separator.

41. The method of claim 40 wherein at least one of a portion of the anode active material and a portion of the cathode active material is associated with at least one of a portion of the anode side and a portion of the cathode side respectively via an adhesive.

42. The method of claim 40 further comprising the step of:
forming slits in at least one of the fold regions of the first current collector.

43. The method of claim 40 wherein the step of forming slits in at least one of the fold regions of the first current collector is conducted via laser.

44. The method of claim 40 further comprising the steps of:
providing a second current collector having at least one fold region, the second current collector being the other of a anode current collector and a cathode current collector;
applying a second active material to the second current collector, the second active material being the other of an anode current collector and a cathode current collector;
removing the second active material from the second current collector proximate the at least one fold region; and
joining the second active material to the opposite side of the separator to which the first active material is joined, in turn, associate the fold regions of each of the second current collector and separator.

45. The method of claim 40 wherein the step of removing comprises at least one of the steps of
abrading the surface of the active material;
removing selected portions of the surface of the active material via laser; and
applying a solvent to the portion of the active material.

46. A method of manufacturing an electrode assembly comprising the steps of
providing a separator having an anode side and a cathode side;
providing a first active material comprising one of an anode active material and a cathode active material;
applying a solvent to one of the first active material and the corresponding side of the separator;
placing the first active material onto the corresponding side of the separator, prior to evaporation of the solvent; and
joining the first active material with the corresponding side of the separator.

47. The method of claim 46 further comprising the steps of
providing a second active material comprising the other of an anode active material and a cathode active material;
applying a solvent to one of the second active material and the corresponding side of the separator;
placing the second active material onto the corresponding side of the separator, prior to evaporation of the solvent; and
joining the second active material with the corresponding side of the separator.
